(19) United States
(12) Patent Application Publication
(10) Pub. No.: US 2023/0330692 A1
(43) Pub. Date: Oct. 19, 2023

(54) COATING SYSTEM FOR A WORKING WIRE OF A SENSOR

(71) Applicant: Zense-Life Inc., Carlsbad, CA (US)

(72) Inventors: Robert James Boock, Carlsbad, CA (US); Sai Kit Wu, Irvine, CA (US)

(73) Assignee: Zense-Life Inc., Carlsbad, CA (US)

(21) Appl. No.: 18/296,471

(22) Filed: Apr. 6, 2023

Related U.S. Application Data
(60) Provisional application No. 63/362,993, filed on Apr. 14, 2022.

(51) Int. Cl. B05C 3/12; B05C 15/00; B05C 13/02

(52) U.S. Cl. CPC B05C 3/125; B05C 15/00; B05C 13/02

(57) ABSTRACT

An apparatus for coating a working wire of a sensor includes a carousel, a robotic arm, and an optical scanner. The carousel includes a first platform, a second platform, and a ring dipping tool. The first platform has a central axis and supports a plurality of stations, all arranged around the central axis. The second platform is positioned above the first platform, with a platform actuator that raises, lowers, and rotates the second platform. The ring dipping tool is coupled to an edge of the second platform and oriented vertically with respect to ground and extending toward the first platform. The robotic arm is configured to transport a fixture, the fixture being configured to hold the wire. The optical scanner is positioned near a wire dipping station of the plurality of stations and configured to scan a position of the wire and a location of the ring dipping tool.

### RELATED APPLICATIONS

This application claims priority to U.S. Provisional Patent Application No. 63/362,993 filed on Apr. 14, 2022, and entitled “Coating System for a Working Wire of a Sensor,” which is hereby incorporated by reference in full.

### BACKGROUND

Medical patients often have diseases or conditions that require the measurement and reporting of biological conditions. For example, if a patient has diabetes, it is important that the patient have an accurate understanding of the level of glucose in their system. Traditionally, diabetes patients have monitored their glucose levels by sticking their finger with a small lance, allowing a drop of blood to form, and then dipping a test strip into the blood. The test strip is positioned in a handheld monitor that performs an analysis on the blood and visually reports the measured glucose level to the patient. Based upon this reported level, the patient makes important decisions on what food to consume, or how much insulin to inject. Although it would be advantageous for the patient to check glucose levels many times throughout the day, many patients fail to adequately monitor their glucose levels due to the pain and inconvenience. As a result, the patient may eat improperly or inject either too much or too little insulin. Either way, the patient has a reduced quality of life and increased chance of doing permanent damage to their health and body. Diabetes is a devastating disease that if not properly controlled can lead to detrimental physiological conditions such as kidney failure, skin ulcers, bleeding in the eyes and eventually blindness, and pain and the eventual amputation of limbs.

Blood glucose levels can significantly rise or lower quickly due to various causes, which can further complicate glucose monitoring. Accordingly, a single glucose measurement provides only a snapshot of the instantaneous level in a patient's body. Such a single measurement provides little information about how the patient's use of glucose is changing over time, or how the patient reacts to specific dosages of insulin. Even a patient that is adhering to a strict schedule of strip testing will likely be making incorrect decisions as to diet, exercise, and insulin injection. This is exacerbated by a patient that is less consistent on their strip testing. To give the patient a more complete understanding of their diabetic condition and to get a better therapeutic result, some diabetic patients are now using continuous glucose monitoring.

Monitoring of glucose levels is critical for diabetes patients. Continuous glucose monitoring (CGM) sensors are a type of device in which glucose is measured from fluid sampled in an area just under the skin multiple times a day. CGM devices typically involve a small housing in which the electronics are located, and which is adhered to the patient's skin to be worn for a period of time. A small needle within the device delivers the subcutaneous sensor which is often electrochemical. Depending upon the patient's condition, continuous glucose monitoring may be performed at different intervals. For example, some continuous glucose monitors may be set to take multiple readings per minute, whereas in other cases the continuous glucose monitor can be set to take readings every hour or so.

Electrochemical glucose sensors operate by using electrodes which typically detect an amperometric signal caused by oxidation of enzymes during conversion of glucose to gluconolactone. The amperometric signal can then be correlated to a glucose concentration. Two-electrode (also referred to as two-pole) designs use a working electrode and a reference electrode, where the reference electrode provides a reference against which the working electrode is biased. The reference electrodes effectively complete the electron flow in the electrochemical circuit. Three-electrode (or three-pole) designs have a working electrode, a reference electrode, and a counter electrode. The counter electrode replenishes ionic loss at the reference electrode and is part of the ionic circuit.

Unfortunately, the cost of using a continuous glucose monitor can be prohibitive for many patients who could benefit greatly from its use. A continuous glucose monitor has two main components. First, there is a housing for the electronics, processor, memory, wireless communication, and power. The housing is typically reusable over extended periods of time, such as months. This housing then connects or communicates to a disposable CGM sensor that is adhered to the patient's body, which typically uses an introducer needle to subcutaneously insert the sensor into the patient. This sensor must be replaced, sometimes as often as every three days, and likely at least once every other week. Thus, the cost to purchase new disposable sensors represents a significant financial burden to patients and insurance companies. Because of this, a substantial number of patients who could benefit from continuous glucose monitoring are not able to use such systems and are forced to rely on the less reliable finger stick monitoring. The working wires are conventionally time consuming to make due to the number of process steps involved and that they must be precisely manufactured to produce accurate results. Accordingly, a new way of efficiently manufacturing working wires is needed.

### SUMMARY

In some embodiments, an apparatus for coating a working wire of a sensor includes a carousel, a robotic arm, and an optical scanner. The carousel includes a first platform, a second platform, and a ring dipping tool. The first platform has a central axis, the first platform supporting a plurality of stations, all arranged around the central axis. The second platform is positioned above the first platform, with a platform actuator that raises, lowers, and rotates the second platform with respect to the first platform. The ring dipping tool is coupled to an edge of the second platform, the ring dipping tool being oriented vertically with respect to ground, and extending toward the first platform. The robotic arm is configured to transport a fixture to the carousel, the fixture being configured to hold the working wire. The optical scanner is positioned near a wire dipping station of the plurality of stations and configured to scan a position of the working wire and a location of the ring dipping tool.

In some embodiments, an apparatus for coating a working wire of a sensor, includes a ring dipping tool having a ring and a shaft, the shaft is oriented vertically with respect to ground. A robotic arm is configured to transport the working wire. An optical scanner is in communication with the robotic arm and configured to scan a position of the working wire and a location of the ring dipping tool. A wire dipping station has a container configured to hold a coating solution, and a coating station actuator is configured to move the ring dipping tool into the container. The robotic arm uses the position of the working wire and the location of the ring dipping tool to insert the working wire through the ring of the ring dipping tool.

### BRIEF DESCRIPTION OF THE DRAWINGS

FIG. 1 is a not-to-scale cross-sectional view of a working wire, in accordance with some embodiments.

FIG. 2 is a schematic of a dipping system, as known in the art.

FIGS. 3A-3B are front and side views, respectively, of a ring dipping process, in accordance with some embodiments.

FIGS. 4A-4C show a ring dipping process, in accordance with some embodiments.

FIGS. 5A-5B are isometric views of a coating system, in accordance with some embodiments.

FIGS. 6A-6B are isometric views of the carousel of FIGS. 5A-5B, in accordance with some embodiments.

FIG. 7A is a close-up view of a ring dipping tool, in accordance with some embodiments.

FIG. 7B is a close-up view of a fixture with working wires ready to be dipped by a ring dipping tool, in accordance with some embodiments.

FIG. 8 is a close-up view of the robotic arm, the holding area and scanner of FIGS. 5A-5B, in accordance with some embodiments.

FIG. 9 is a close-up view of the measurement station from FIG. 5B, in accordance with some embodiments.

FIG. 10 shows ring designs that may be used in a ring dipping process, in accordance with some embodiments.

FIG. 11 is a close-up isometric view of a robotic arm having a gas supply tube, in accordance with some embodiments.

FIGS. 12A-12B are isometric views of an environmental chamber with a coating system inside, in accordance with some embodiments.

FIG. 12C is an isometric view of an environmental chamber, in accordance with some embodiments.

FIGS. 13A-13C are various views showing a recirculation path of an environmental chamber, in accordance with some embodiments.

FIG. 14 is a simplified schematic diagram showing an example server for use in a controller, in accordance with some embodiments.

### DETAILED DESCRIPTION

Embodiments disclose systems and processes for manufacturing working wires for sensor, such as a continuous biological sensor, where the embodiments reduce cost and improve accuracy and efficiency compared to known art. The continuous biological sensor may be, for example, a continuous glucose monitor, in which the working wire includes an enzyme layer to detect the level of glucose in a patient's blood. In other embodiments, the biological sensor can be a metabolic sensor for measuring other metabolic characteristics such as ketones, lactates or fatty acids. The sensor uses a working wire (i.e., electrode for the sensor) that has a core and several concentrically formed membrane layers.

In some embodiments, a coating system uses ring dipping for coating working wires. The ring dipping involves holding the working wire horizontally and inserting it through a ring of a dipping tool, where the ring is oriented vertically. The coating system includes multiple stations mounted in a carousel, beneficially enabling the ring dipping to be performed continuously in an automated manner and enabling multiple working wires to be processed in an efficient manner. The stations can include a wire dipping station and various stations for the ring dipping tool, such as a cleaning station, a drying station, and a coating station to reapply coating solution to the tool. The coating system uniquely includes an optical scanner that scans the position of the working wire and the ring dipping tool such that the working wire can accurately be inserted through the ring. Embodiments include an automated measurement tool that measures layer thicknesses of coatings on the working wires after each dip. The measurements are used as feedback for the coating system to adjust dipping parameters such as insertion and withdrawal speed of the working wire through the ring dipping tool, and/or an amount of coating film to be placed on the ring dipping tool. The coating system may be configured to enable multiple fixtures to be processed in parallel, where each fixture has one or more working wires.

The coating systems and methods of the present disclosure provide improved accuracy and increased throughput compared to conventional techniques. In some aspects, the automated system measures dimensions of working wires while they are progressing through a dipping process and uses the measurements to adjust dipping parameters in real-time. The measurement system can take multiple measurements along a length of the working wires and can also measure multiples wires that are mounted in a fixture. By providing thorough monitoring of coating thicknesses and by doing so in real-time, more efficient and accurate dip coating of working wires is achieved compared to conventional methods. The systems and methods may optimize the manufacturing process, such as by reducing (e.g., minimizing) the number of dips required to achieve a desired coating thickness. In other aspects, scanning of the working wire position and ring dipping tool enables the robotic arm to account for positional variances that may occur from wire to wire and/or for non-straightness of an individual wire (e.g., a wire sagging toward its end that is not held by the fixture). The scanning thus improves the accuracy in centering the wire as it is being moved through the ring dipping tool.

Embodiments may also include an environmental chamber for housing the coating system, where the chamber provides highly accurate environmental conditions throughout the chamber. The chamber includes individually controlled fans that can adjust airflow based on humidity sensor feedback from a local region in the chamber. A recirculation path within the chamber along with customizable vent plates enable uniform air flow to be created in the chamber. Ports for dry gas and ambient air are provided, where valves are adjusted based on feedback from humidity sensors to enable relative humidity levels in the chamber to be controlled in a highly accurate manner.

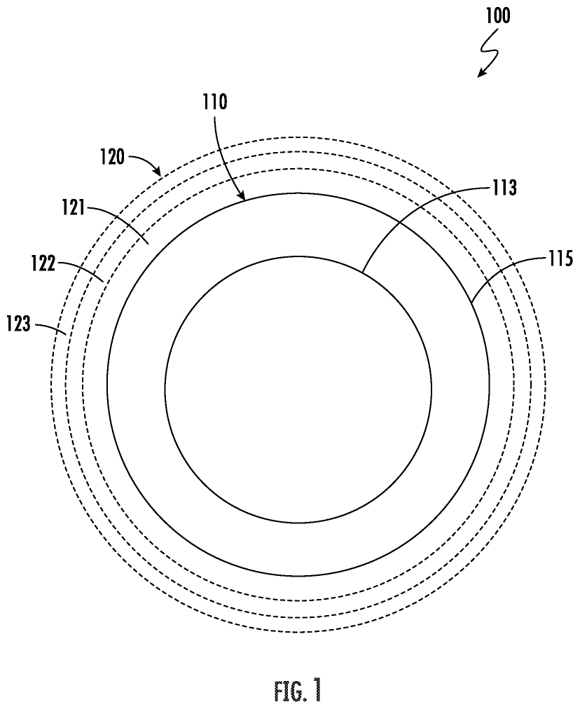

Referring to FIG. 1, a cross-sectional view of a working wire 100 is illustrated in accordance with some embodiments. In this example, the working wire 100 is an elongated wire having a circular cross-section. It will be understood that other cross-sections may be used, such as square, rectangular, triangular, or other geometric shapes. Furthermore, the working wire 100 may take other forms, such as a plate or ribbon. The working wire may be used as a working electrode of a continuous biological sensor, such as a working electrode of a continuous glucose monitor.

In the illustrated example, the working wire 100 has a substrate 110 onto which biological membranes 120 may be disposed. The types of biological membranes that may be manufactured by the present methods and systems will not be described herein, but may include biological membranes that are well-known and other types of coating layers on working wires for biological sensors. In one example as illustrated, the biological membranes 120 include an interference membrane 121 (which may also be referred to as an interference layer) on the substrate 110, an enzyme membrane 122 (i.e., enzyme layer) on the interference membrane 121, and a glucose limiting membrane 123 (i.e., glucose limiting layer) on the enzyme membrane 122. In some embodiments, a protective or outer coating may be optionally applied over the glucose limiting membrane 123. Although the working wire 100 is illustrated as having three membranes 120, it will be understood that the membranes 120 may be more or fewer in number.

The substrate 110 may be comprised of a core 113 with an outer layer 115. In the example of FIG. 1, the core 113 is an elongated wire that is dense, ductile, very hard, easily fabricated, highly conductive of heat and electricity, and may also be resistant to corrosion. Example materials for core 113 include tantalum, carbon, or Co—Cr alloys. The core 113 may have the outer layer 115, such as of platinum, deposited or applied using an electroplating process. It will be understood that other processes may be used for applying the outer layer 115 to the core 113. For a glucose monitor, the platinum outer layer 115 facilitates a reaction where the hydrogen peroxide reacts to produce water and hydrogen ions, and two electrons are generated. The electrons are drawn into the platinum by a bias voltage placed across the platinum wire and a reference electrode. In this way, the magnitude of the electrical current flowing in the platinum is intended to be related to the number of hydrogen peroxide reactions, which in turn is proportional to the number of glucose molecules oxidized. A measurement of the electrical current on the platinum wire can thereby be associated with a particular level of glucose in the patient's blood or interstitial fluid (ISF).

The core 113, outer layer 115, interference membrane 121, and enzyme membrane 122 form key aspects of working wire 100. Other layers and/or membranes may be added depending upon the biological substance being tested for, and application-specific requirements. In some cases, the core 113 may have an inner core portion (not shown). For example, if the substrate (core 113) is made from tantalum, an inner core of titanium or titanium alloy may be included to provide additional strength and straightness.

In some cases, one or more membranes (i.e., layers) may be provided over the enzyme membrane 122. For example, a glucose limiting membrane 123 may be layered on top of the enzyme membrane 122. This glucose limiting membrane 123 may limit the number of glucose molecules that can pass through the glucose limiting membrane 123 and into the enzyme membrane 122. The glucose limiting membrane 123 can be configured as described in U.S. patent application Ser. No. 16/375,877, entitled “Enhanced Glucose Limiting Membrane for a Working Electrode of a Continuous Biological Sensor,” which is owned by the assignee of the present disclosure and is incorporated herein by reference as if set forth in its entirety. In some cases, the addition of the glucose limiting membrane 123 has been shown to enable better performance of the overall working wire 100.

An interference membrane 121 is applied over the outer layer 115. The interference membrane 121 may be disposed between the enzyme membrane 122 and the outer layer 115. This interference membrane 121 is constructed to fully wrap the outer layer 115, thereby protecting the outer layer 115 from further oxidation effects. The interference membrane 121 is also constructed to substantially restrict the passage of larger molecules, such as acetaminophen, to reduce contaminants that can reach the platinum and skew results. Further, the interference membrane 121 may pass a controlled level of hydrogen peroxide (H₂O₂) from the enzyme membrane 122 to the platinum outer layer 115. Compositions for the interference membrane 121 and enzyme membrane 122 may be as described in U.S. patent application Ser. No. 17/449,562, entitled “Working Wire for a Continuous Biological Sensor with an Immobilization Network,” and U.S. patent application Ser. No. 17/449,380, entitled “In-Vivo Glucose Specific Sensor,” which are owned by the assignee of the present disclosure and incorporated herein by reference as if set forth in their entirety.

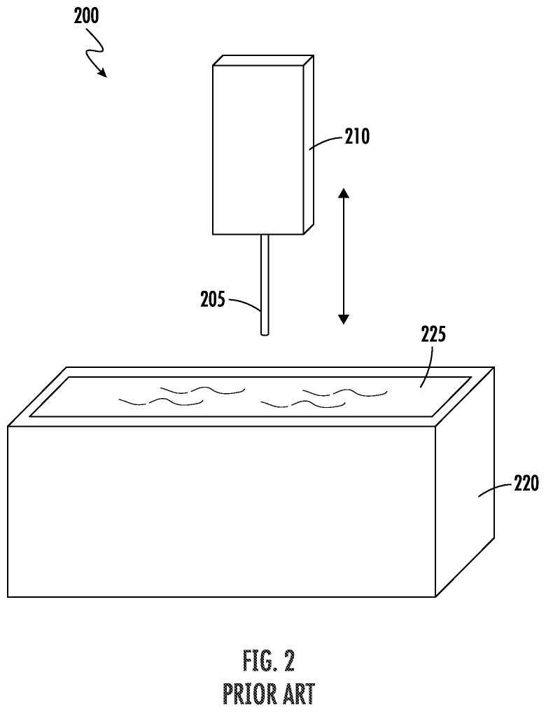

FIG. 2 is a schematic of a dipping system, as known in the art. An isometric view of a dipping station 200 for one type of coating process known in the art is shown, where the parts (e.g., wires 205) to be coated are lowered vertically into a tub 220 of coating solution 225. Dipping station 200 is shown with a fixture 210 and the tub 220 with the coating solution 225. One or more wires 205 may be mounted into the fixture 210, where the fixture 210 is depicted as a block for simplicity. The fixture 210 is used for transporting the wires 205 through a dipping process during manufacturing. The fixture 210 may also be referred to as a holder or tray. Multiple dips in the coating solution 225 may be required to build up the number of layers for achieving a desired final thickness of the membrane on the wire 205. In such cases, the wire 205 may be dipped to create one layer, then set aside to cure, and then the dipping is repeated to add the next layer.

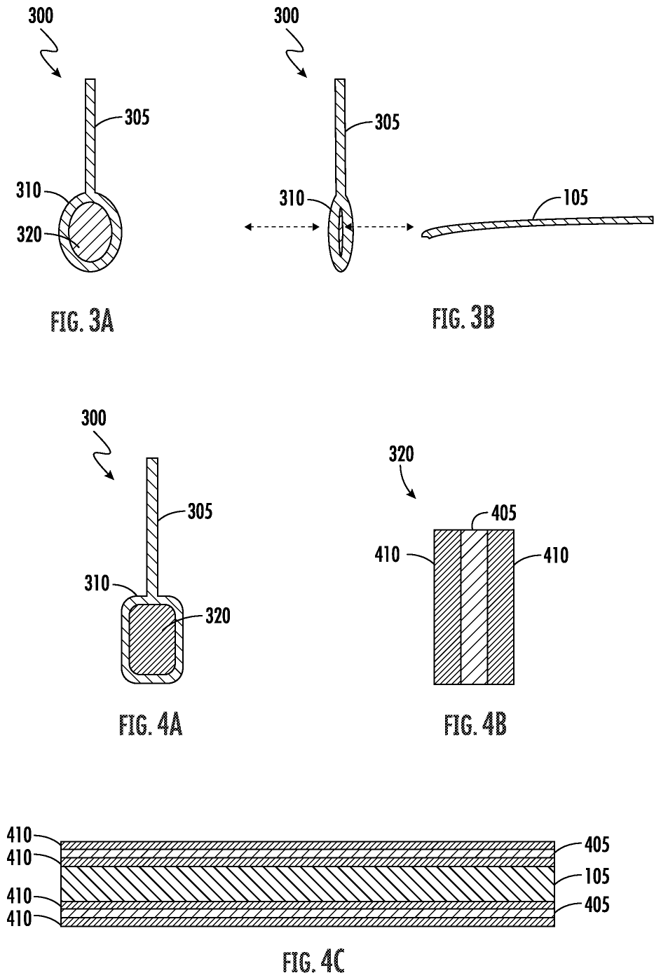

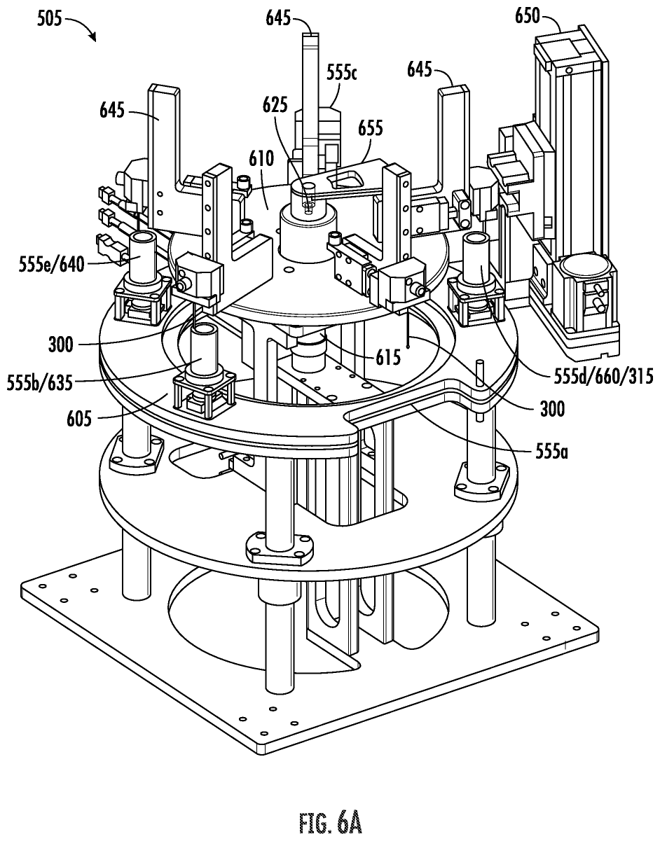

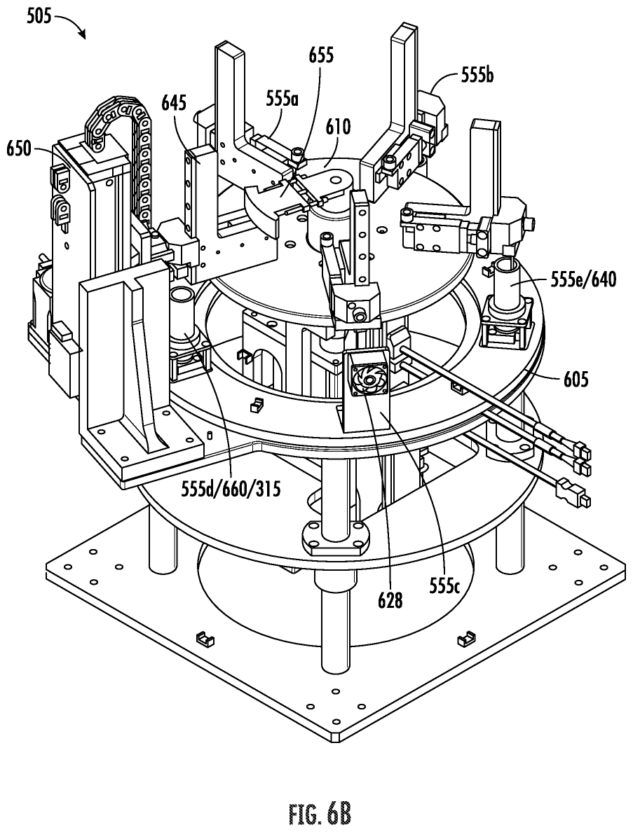

FIGS. 3A-3B are front and side views, respectively, of another type of dipping process involving a ring dipping tool 300, in accordance with some embodiments. Ring dipping tool 300, which may also be referred to as a ring dipper or dipping tool, has a shaft 305 and a ring 310 at the end of the shaft 305. The ring 310 (and often some of the shaft 305) is immersed in a coating solution 315 (as shown in FIGS. 6A and 6B, and similar to coating solution 225 in FIG. 2) to form a film 320 of coating across the opening of the ring 310. The part to be coated, such as the wire 105 in the embodiment of FIG. 3B, is inserted through the ring 310. Conventionally, ring dipping is difficult to scale up for commercial manufacturing due to factors such as inconsistent coating film thickness across the ring or inconsistent coating film thickness from one dip to another, which results in inconsistent layers being formed on the part. For a working wire of a biological sensor, these inconsistencies can result in varying sensing properties, which ultimately affects the product performance. Consequently, ring dipping is conventionally not used at a large scale, and/or is used with coating materials having a uniform composition.

In embodiments of the present disclosure, the wires 105 may be positioned horizontally when undergoing ring dipping. As can be seen in FIG. 3B, gravity may cause the wire 105 to sag along its length (even if the wire is not horizontal), resulting in the wire 105 not being centered when inserted through the ring 310 if the wire 105 is moved in a straight path. Alternatively, the wire 105 itself may not be precisely straight. Either of these scenarios consequently can result in non-uniformities in the coating layer along the length of the wire 105 or can create defects if the wire 105 touches the ring 310 itself. Thus, ring dipping presents further technical challenges that are complex to handle, especially for small parts such as sensor wires 105 that are being inserted through rings 310 that can have openings of approximately 0.5 mm to 3 mm wide.

FIGS. 4A-4C show a ring dipping process, in accordance with some embodiments. FIGS. 4A-4C illustrate a type of coating where embodiments of the disclosure uniquely recognize that ring dipping with a horizontal orientation of the wire 105 is desirable. In FIG. 4A, a ring 310 is shown with the film 320 of the coating solution 315. The ring 310 is a rounded square in this embodiment rather than being oval shaped as in FIG. 3A, demonstrating that different ring shapes can be used. The composition of the coating solution 315 in this embodiment is made of both hydrophobic and hydrophilic materials, resulting in a non-uniform composition. In the side view of the film 320 shown in FIG. 4B, the vertical orientation of the ring 310 results in hydrophobic regions 410 that sandwich a hydrophilic region 405 between them. This is due to the hydrophobic materials tending to rise relative to the hydrophilic materials. The hydrophobic regions 410 and the hydrophilic regions 405 form multiple layer interfaces on the wire 105 when the wire 105 is inserted into and withdrawn from the coating solution 315 during a single dip cycle, as shown in the side cross-sectional view of the wire 105 in FIG. 4C. Having more interfaces in the layers of a membrane of a continuous glucose monitor was found, in relation to the present disclosure, to impart beneficial properties. For example, having more of the hydrophobic-hydrophilic interfaces on the wire 105 resulted in a more stable drift profile for the sensitivity of the sensor. In addition, the greater number of interfaces was unexpectedly found to achieve the same sensitivity with less overall membrane thickness than a membrane with less interfaces but a thicker membrane. Achieving a target sensitivity with a thinner membrane beneficially enables the working wire 100 to be manufactured in less time than thicker membranes, consequently reducing cost and/or increasing throughput. The present disclosure describes systems and methods that overcome the challenges of ring dipping, particularly with an elongated wire 105 being dipped horizontally, to enable various types of compositions to be utilized at a commercially manufacturable scale.

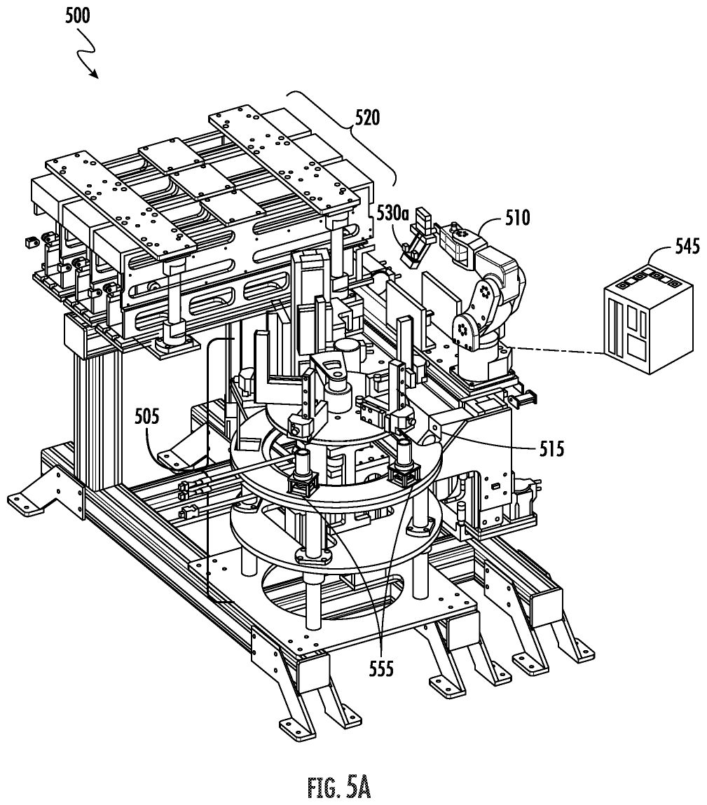

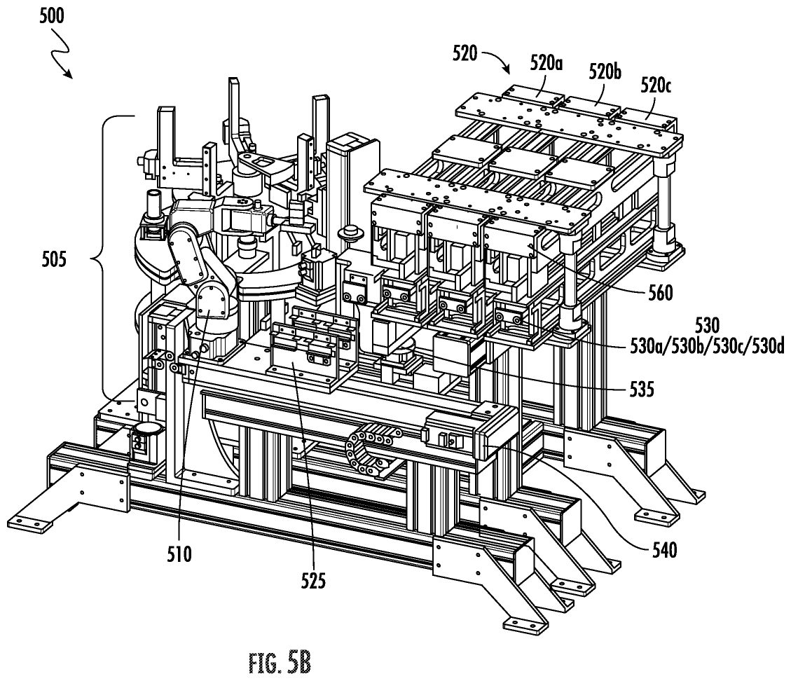

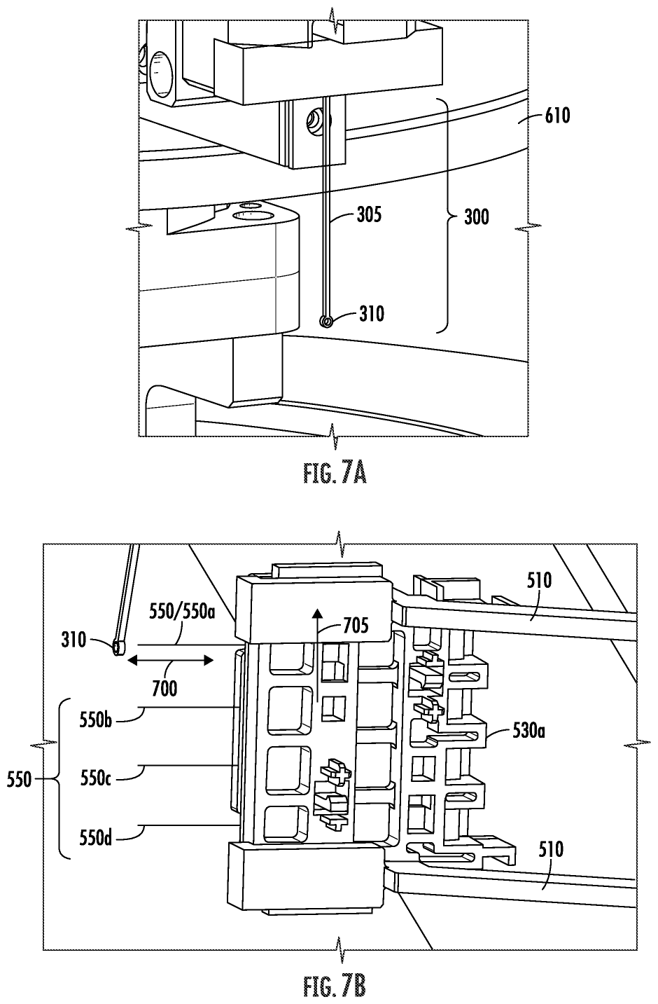

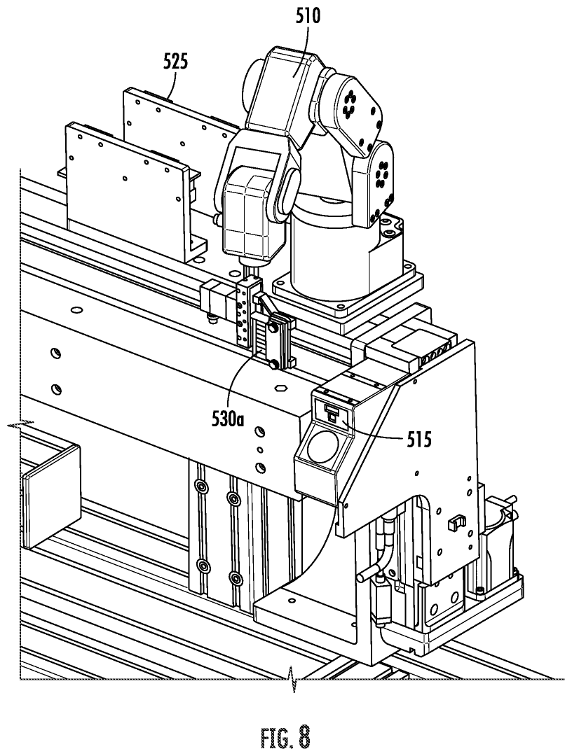

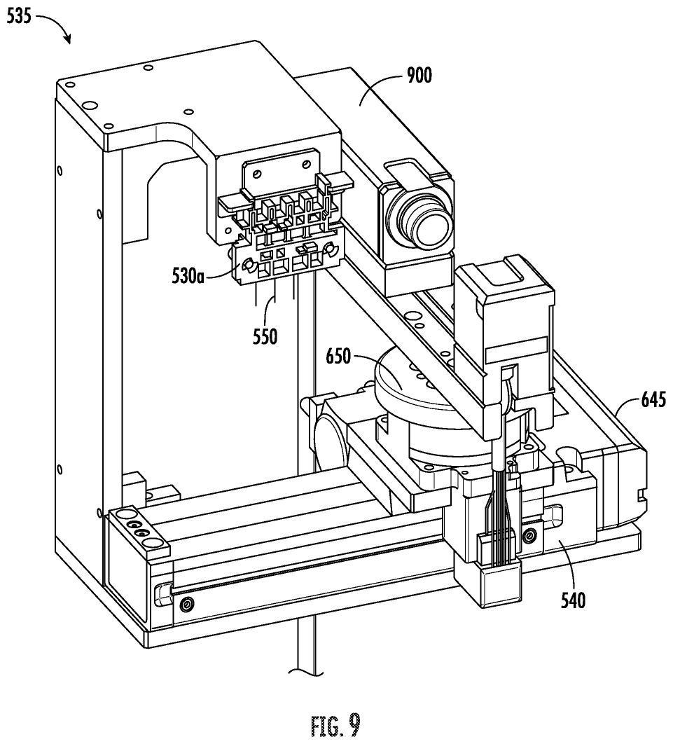

FIGS. 5A-5B are isometric views of a coating system 500, in accordance with some embodiments. Coating system 500 is an apparatus for coating a wire 105 of a sensor, and includes a carousel 505, a robotic arm 510, and a scanner such as an optical scanner 515. For example, the wire 105 or wires 105 are work-in-progress (“WIP”) wires 550 (as shown in FIGS. 7A-7B and 9) being processed by the coating system 500. The coating system 500 in this embodiment also includes a cassette area 520 having cassettes such as 520a, 520b, 520c . . . 520n, and a holding area 525 for storing or temporarily holding fixtures 530 (such as 530a, 530b, 530c, 530d) that have WIP wires 550. A measurement station 535 can also be seen in FIG. 5B. The robotic arm 510 moves the fixtures 530 to various portions of the coating system 500, such as between the cassette area 520, holding area 525, carousel 505, optical scanner 515, and measurement station 535. The robotic arm 510 is configured to transport the fixture 530 (such as first fixture 530a) to the carousel 505, the first fixture 530a being configured to hold one or more WIP wires 550. The robotic arm 510 may be an articulating robot, such as a 6-axis robot having articulated joints. The robotic arm 510 may be moved within the system by a linear stage actuator 540 (FIG. 5B). The system may include a controller 545 that controls the robotic arm 510 and carousel 505. For example, the controller 545 may be configured to automatically and electronically move the robotic arm 510 and rotate the carousel 505 such that a plurality of WIP wires 550 can be processed by the carousel 505, and multiple ring dipping tools 300 can be prepared and cleaned in parallel with each other.

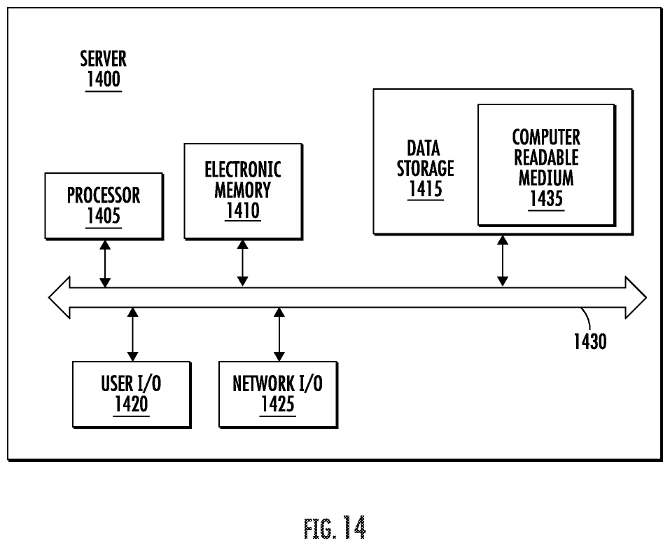

The controller 545 may be a computer hardware processor (see processor 1405 in FIG. 14) that is separate from and connected to the coating system 500, such as to the robotic arm 510, either physically (e.g., hard-wired), or wirelessly. In other embodiments, the controller 545 may comprise one or more processors incorporated into the robotic arm 510 and/or other components of the coating system 500 such as the carousel 505, optical scanner 515 and measurement station 535. The WIP wires 550 being processed by the coating system 500 may have some or none of the membrane layers applied as the WIP wires 550 pass through a plurality of carousel stations 555 on the carousel 505. For example, the WIP wires 550 may consist of only a substrate 110 or may have the substrate 110 and an enzyme membrane 122, or may have the substrate 110, an enzyme membrane 122 and an interference membrane 121. The coating system 500 may apply one or more of the enzyme membrane 122, the interference membrane 121, and/or the glucose limiting membrane 123, all of which may be efficiently and accurately applied through the dipping process.

The cassette area 520 serves as a rack for holding fixtures 530 containing the WIP wires 550. In the illustrated embodiment of FIGS. 5A-5B there are three cassettes, 520a, 520b and 520c, each one of which is a linear tray into which the fixtures 530 can be slid and stacked side by side in the cassette 520a, 520b or 520c. For cassettes 520a, 520b, 520c with uncoated WIP wires 550, the fixtures 530 are pre-loaded in the cassette 520a, 520b or 520c and advanced to the front 560 of the cassette area 520, to be picked up by the robotic arm 510 and processed through the coating system 500. One cassette 520a, 520b or 520c of the cassette area 520 can be empty initially, for placing fixtures 530 into after the WIP wires 550 have been fully completed. The holding area 525 (see FIG. 5B) may be used to temporarily store fixtures 530 with partially coated WIP wires 550 (i.e., some layers have been dipped but more layers need to be added) while the fixtures 530 are waiting to be moved or processed at the next station of the plurality of carousel stations 555.

FIGS. 6A-6B are isometric views of the carousel 505 of FIGS. 5A-5B, in accordance with some embodiments. FIG. 6A is an isometric view of the carousel 505 of the coating system 500, showing a first platform 605 that supports the various carousel stations 555 of the dipping process. A second platform 610 is positioned above the first platform 605, with a platform actuator 615 that raises, lowers, and rotates the second platform 610 with respect to the first platform 605. The platform actuator 615 may be located, for example, above the second platform 610, or between the first platform 605 and second platform 610, or below the first platform 605 and coupled to the second platform 610 through a central axis 625. One of the stations of the plurality of carousel stations 555 on the first platform 605 is a wire dipping station 555a for dipping the WIP wires 550 through the ring dipping tool 300. Other carousel stations 555 on the first platform 605 are for maintaining the ring dipping tool 300, including a first cleaning station 555b, a drying station 555c, and a coating station 555d for applying coating solution 315 to the ring dipping tool 300. All of the carousel stations 555 for the dipping process are arranged around the central axis 625. Two cleaning stations such as first cleaning station 555b and second cleaning station 555e are shown in this figure, but in other embodiments only one cleaning station may be included, or more than one cleaning station. The cleaning stations 555b and 555e each include cleaning containers 635 and 640 respectively, for holding a cleaning solution, where the first cleaning container 635 of the first cleaning station 555b may hold the same or a different solution from the second cleaning container 640 of the second cleaning station 555e. The drying station 555c is visible in FIG. 6B, showing a fan 628 that blows air to dry the cleaning solvents off of the ring dipping tool 300.

One or more ring dipping tools 300 are coupled to an edge of the second platform 610, each coupled by a linear stage 645 (e.g., a rail) positioned vertically to move the ring dipping tool 300 up and down relative to the second platform 610. The ring dipping tool 300 is oriented vertically with respect to ground and extends toward the first platform 605. In this embodiment, one ring dipping tool 300 is present for each of the carousel stations 555 so that usage of the ring dipping tools 300 can occur in parallel. For example, a plurality of ring dipping tools 300 may be coupled to the edge of the second platform 610 and spaced apart from each other at locations corresponding to the coating station 555d, the wire dipping station 555a, the cleaning station 555b and 555e, and the drying station 555c (i.e., five ring dipping tools 300, since there are two cleaning stations 555b and 555e in this embodiment).

In operation, the first platform 605 remains fixed in position, and the second platform 610 rotates with respect to the first platform 605. The second platform 610 is lifted from a nominal height (i.e., baseline distance from the first platform 605) before rotating so that each ring dipping tool 300 can be clear from colliding with any of the containers of the carousel stations 555 (such as first and second cleaning containers 635 and 640) before being moved to the next station. The second platform 610 is then lowered back to its nominal height when the ring dipping tools 300 have been positioned at the next station. A clean ring dipping tool 300 (i.e., no coating solution 315 on it) begins at the coating station, 555d where a coating station actuator 650 is fixedly positioned opposite the coating station 555d. A decoupler 655 is attached to the center axis 625 and faces toward the coating station 555d. Although the linear stages 645 holding the ring dipping tools 300 are normally fixed relative to the second platform 610, when a linear stage 645 is at the coating station 555d, the decoupler 655 unlocks the linear stage 645. The coating station actuator 650 is connectable to the linear stage 645 to move (e.g., lower) the ring dipping tool 300 into the first coating container 660 of the coating station 555d when the linear stage 645 is unlocked. The first coating container 660 holds a coating solution 315 to be applied to the ring dipping tool 300, for creating a layer on the WIP wires 550. The coating solution 315 may be used to create layers for a working wire of a sensor, such as the interference membrane 121, enzyme membrane 122, or glucose limiting membrane 123 of FIG. 1, where each membrane may require several dips (i.e., multiple coating iterations, or layers) to build up a desired thickness of the full membrane. The first coating container 660 is shown as a cylinder, but in other embodiments could be a bowl or cup and could have other cross-sectional shapes such as a rectangle. Parameters for the coating station actuator 650 such as movement speed and travel distance may be controlled by using feedback from previously dipped wires, as shall be described further below.

After having coating applied to the ring dipping tool 300, the second platform 610 is raised and rotated, moving the coated ring dipping tool 300 to the wire dipping station 555a. FIG. 7A is a close-up view of a ring dipping tool 300, in accordance with some embodiments. The ring dipping tool 300 is coupled to an edge of the second platform 610 and has a shaft 305 and ring 310 at the end of the shaft 305. FIG. 7B is a close-up view of a fixture with working wires ready to be dipped by a ring dipping tool 300, in accordance with some embodiments. FIG. 7B shows WIP wires 550 (550a, 550b, 550c, 550d . . . 550n) positioned to be dipped through the ring 310. In this embodiment, the first fixture 530a is configured to hold a plurality of WIP wires 550 to enable more than one wire to be processed by the carousel 505 while the robotic arm 510 is in place at the dipping station 555a. The WIP wires 550 may be secured into the fixture 530 such as the first fixture 530a, for example, by clamps, spring-loaded clips, set screws, adhesive fasteners, or other mechanisms. Four WIP wires 550 such as 550a, 550b, 550c and 550d, are shown in this embodiment, but the fixture 530a may be configured to hold more or fewer WIP wires 550 in other embodiments. The WIP wires 550 are mounted in a single row in this embodiment, spaced apart from each other so that each one can be measured individually from various angles. In other embodiments the WIP wires 550 may be arranged in other fashions such as in more than one row, aligned or staggered from each other, so long as sufficient space is between the wires to enable each WIP wire 550 to be measured separately.

In FIG. 7B, the robotic arm 510 holds the first fixture 530a such that WIP wire 550a is positioned to be dipped. The robotic arm 510 moves the WIP wire 550a forward and backward through the ring 310, as indicated by the double-headed arrow 700 in the figure, to perform the dipping. After WIP wire 550a has been dipped, another ring dipping tool 300 with fresh coating solution 315 is placed in front of the first fixture 530a by rotating the carousel 505 (having multiple of the ring dipping tools 300 mounted on it), and the robotic arm 510 is moved upwards as indicated by the upward arrow 705 so that WIP wire 550b can be dipped. This cycle is repeated for WIP wire 550c and WIP wire 550d. After all the WIP wires 550 on the first fixture 530a have been coated with a layer of coating solution 315, the first fixture 530a can be moved to another area for further processing, such as to be measured, cured, or unloading if the full membrane has been completed.

Returning to FIGS. 6A-6B, after a ring dipping tool 300 has been used at the wire dipping station 555a, the second platform 610 is rotated again to move the ring dipping tool 300 to the first cleaning station 555b. To execute the movement, the second platform 610 is raised, rotated, and then lowered to its nominal position (height), where the lowering places the ring 310 and generally at least a portion of the shaft 305 into the first cleaning container 635 at the cleaning station 555b. The first cleaning container 635 has a solvent or other solution to remove coating solution 315 from the ring 310, such as by submerging the ring dipping tool 300 in the solvent for an amount of time such as 5 to 15 seconds. The cleaning should occur because the coating solution 315 cures on the ring 310 during the dipping process, leaving a residue. The ring 310 should be cleaned after each dip because residual coating solution 315 will affect how the next film 320 is formed on the ring 310, which can then impact how the coating is laid onto the WIP wire 550. If more than one cleaning station is present, a subsequent immersion of the ring dipping tool 300 into a cleaning liquid is performed at the next cleaning station such as cleaning station 555e. Finally, the ring dipping tool 300 is dried at the drying station 555c, and then moved to the coating station 555d to begin the cycle again.

While the ring dipping tools 300 are rotating, the WIP wires 550 are being dipped at the wire dipping station 555a. Each time a freshly coated ring dipping tool 300 is rotated to the wire dipping station 555a, the next wire on the first fixture 530a can be moved into place for dipping. For example, referring again to FIG. 7B, after WIP wire 550a has been dipped, the robotic arm 510 moves WIP wire 550b into proper position (as shall be described for FIG. 8) relative to the ring dipping tool 300. Then WIP wire 550c is dipped when the next ring dipping tool 300 is rotated, and finally WIP wire 550d. After all the WIP wires 550 on this first fixture 530a have had a layer of coating applied, the robotic arm 510 can move the first fixture 530a to the holding area 525 to cure. The robotic arm 510 can then pick up a second fixture 530b for processing by the carousel 505. After the first fixture 530a has cured, the robotic arm 510 can move the first fixture 530a to a measurement station 535 (as shall be described for FIG. 9) to determine if dipping parameters need to be adjusted before the next layer of coating is applied to the wires on fixture 530a. If more layers are needed, the first fixture 530a can be returned to the carousel 505 while the second fixture 530b is curing. If all layers of the membrane have been fully completed, the robotic arm 510 can move the first fixture 530a to the cassette area 520. In some embodiments, a single robot moves multiple fixtures 530 through the coating system 500. In some embodiments, more than one robot can be included in the system to perform parallel handling of multiple wire fixtures 530.

FIG. 8 is a close-up view of the robotic arm 510, the holding area 525, and optical scanner 515, in accordance with some embodiments. The optical scanner 515 is positioned near the wire dipping station 555a to scan the three-dimensional positions of the WIP wire 550 (e.g., 550a, 550b, 550c or 550d) and ring dipping tool 300 when the WIP wire 550 is ready to be dipped (e.g., WIP wire 550a of FIG. 7B). The optical scanner 515 is in communication with the robotic arm 510, via the controller 545, such that the robotic arm 510 uses the position of the WIP wire 550a and the location of the ring dipping tool 300 while inserting the WIP wire 550a through the ring dipping tool 300 at the wire dipping station 555a. For example, the optical scanner 515 may provide the lengthwise profile of the WIP wire 550a to the controller 545, which controls the robotic arm 510 so that the robotic arm 510 can appropriately direct the WIP wire 550a through the ring 310 as the WIP wire 550a is advanced and withdrawn. The robotic arm 510 inserts the WIP wire 550a into the ring 310 on a path that is perpendicular to the plane of the ring 310, adjusting the robotic arm's trajectory to compensate for the information about the lengthwise profile of the WIP wire 550a (e.g., variances due to bending from gravity and/or variance in the innate straightness of the WIP wire 550a) and the ring 310 position provided by the optical scanner 515. The inserting of the WIP wire 550a relative to the ring 310, based on the scanned positions, can be highly accurate, such as up to 5 microns of a target position. The optical scanner 515 also scans the ring 310 so that the robotic tool can account for any changes in orientation of the ring 310 between cycles with respect to the WIP wire 550a. Inclusion of the optical scanner 515 at the wire dipping station 555a, to properly move the WIP wire 550a through the ring dipping tool 300, provides high accuracy of the layers being deposited onto the WIP wire 550a.

FIG. 9 shows a close-up view of the measurement station 535 from FIG. 5B, in accordance with some embodiments. The measurement station 535 may be an automated measurement system in communication with the coating station actuator 650, via the controller 545 (as shown in FIG. 5A). Measurements of coating thicknesses on the WIP wire 550a, taken by the automated measurement system, provide feedback to the controller 545 for controlling the coating station actuator 650. The automated measurement system can also provide feedback of layer thicknesses to the controller 545, to control the wire dipping station 555a. This closed-loop feedback can be used to alter parameters for the next layer to be dipped onto the WIP wires 550 so that the overall membrane can be precisely built to the desired thickness. For example, the insertion or withdrawal speeds of the WIP wire 550a through the ring 310 can be altered to apply a thinner or thicker layer on the WIP wire 550a during the next cycle. In another example, immersion or withdrawal speeds of the ring dipping tool 300 into the coating solution 315 can be adjusted to create a thinner or thicker film 320 on the ring 310. The speeds and even the immersion depth of the ring dipping tool 300 in the coating solution 315 can affect the film thickness since solution can flow down from the shaft 305 into the ring 310 area. By adjusting for these complex interactions in-line, after every dip is performed, layer thicknesses of the WIP wire 550a can be controlled to a highly accurate level, such as within 1 to 3 microns of a target layer thickness. The thicknesses to be created can also be adjusted to achieve the desired membrane thickness within a maximum number of dips.

In embodiments, the automated measurement system is an in-line optical measurement tool 900 (i.e., optical measurement tool 900 used during the manufacturing process), where the diameter of each WIP wire 550 is measured to derive a coating thickness that has accumulated from the last dipping cycle. The optical measurement tool 900 may be, for example, an optical micrometer that utilizes a laser beam to measure dimensions in a non-contact manner. The micrometer detects the size of the WIP wire 550 by measuring the shadow of the object that is within the path of the laser beam. In the embodiment shown, the optical measurement tool 900 is mounted on a stage that has both linear and rotational actuators, which enables the optical measurement tool 900 to be moved so that it can measure the WIP wires 550 on the fixture 530 (e.g., the first fixture 530a in FIG. 8) from various angles and at various points along the length of the WIP wires 550. In another embodiment, the robotic arm 510 may be utilized to move the first fixture 530a while the WIP wires 550 are being scanned by the optical measurement tool 900. In either case, each WIP wire 550 in the first fixture 530a may have its thickness measured along its entire length and at different angles around its entire circumference. In this way, thickness is defined for every WIP wire 550 at each dip for both length and angular rotation. Measurements can be made at more than one location along a length of the WIP wire 550, and the first fixture 530a can be rotated around a longitudinal axis of the WIP wire 550 so that the diameters are measured again along their length from a different orientation. In an example embodiment, each WIP wire 550 can be measured at 10 to 40 points along its length, and from three different angles at each point. When the WIP wires 550 have been measured as achieving the desired total coated membrane thickness, within an acceptable target window, the WIP wires 550 are unloaded, such as being placed in the cassette area 520.

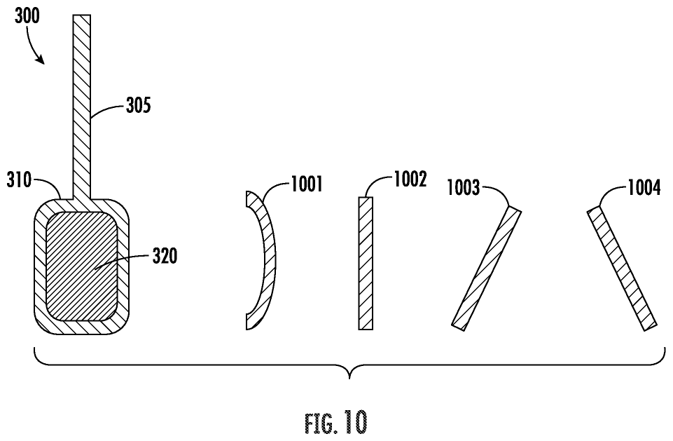

FIG. 10 shows ring 310 designs that can be used to further customize how the layers are formed on the WIP wires 550a, in accordance with some embodiments. The side profiles 1001-1004 shown in FIG. 10 illustrate that in a plane perpendicular to the ring 310, the ring 310 can be curved (profile 1001), flat (profile 1002), inclined downward (profile 1003) or inclined upward (profile 1004). Because the coating solution 315 will flow toward the bottom of the ring 310 due to gravity, the different side profiles affect how that flow occurs. In turn, these side profiles will affect how the coating film 320 is deposited onto the WIP wire 550a, and thus the thickness of the layer that forms.

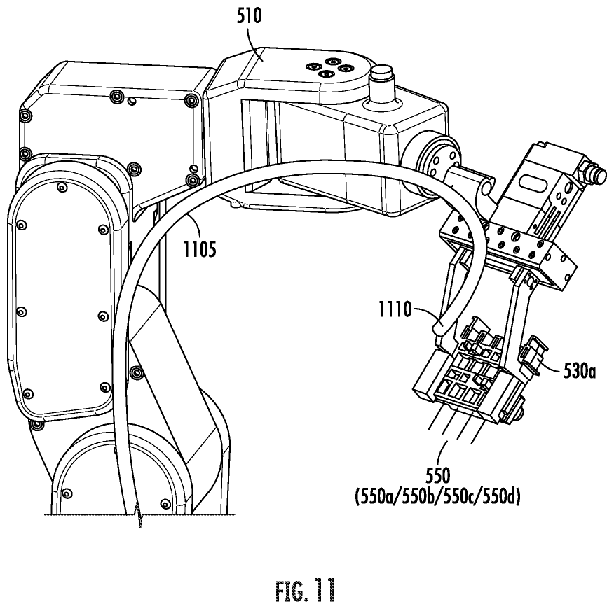

FIG. 11 is a close-up isometric view of the robotic arm 510 having a gas supply tube 1105, in accordance with some embodiments. The embodiment shows the coating process can be further controlled by supplying gas of a particular relative humidity and/or temperature directly to the wire dipping station 555a. In the figure, a gas supply tube 1105 is coupled to the robotic arm 510 to provide controlled gas such as air to the wire dipping station 555a, with an end 1110 of the gas supply tube 1105 being near a working end of the robotic arm 510 that holds the fixture 530a. The temperature and humidity of the environment during a dipping process can affect how a coating layer forms by affecting factors such as liquid flow and solvent evaporation. In the embodiment of FIG. 11, delivering controlled gas through the gas supply tube 1105 can help control the dipping environment in a localized manner.

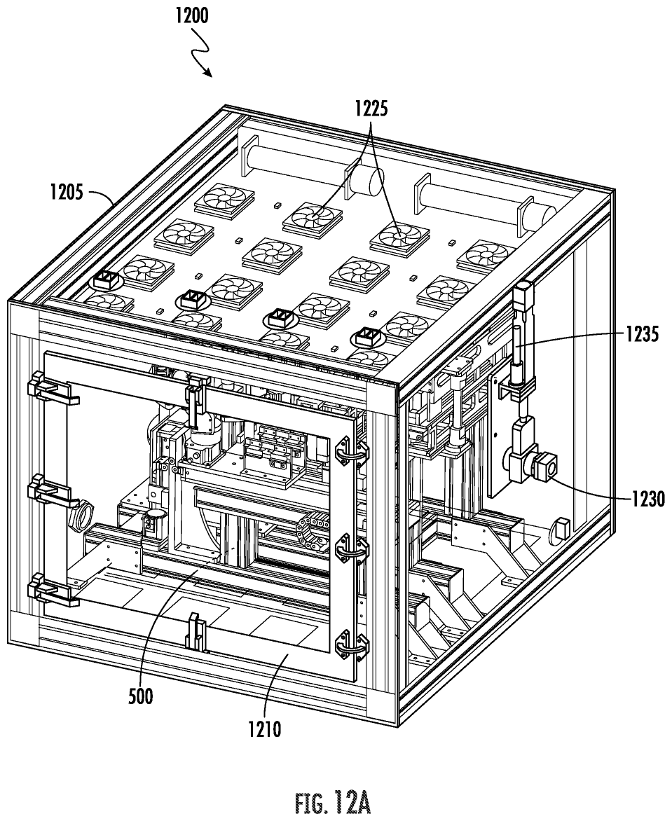

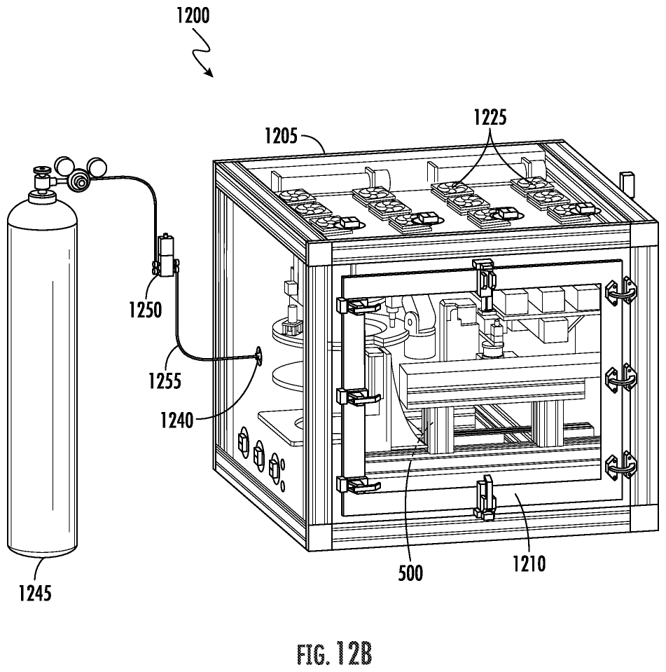

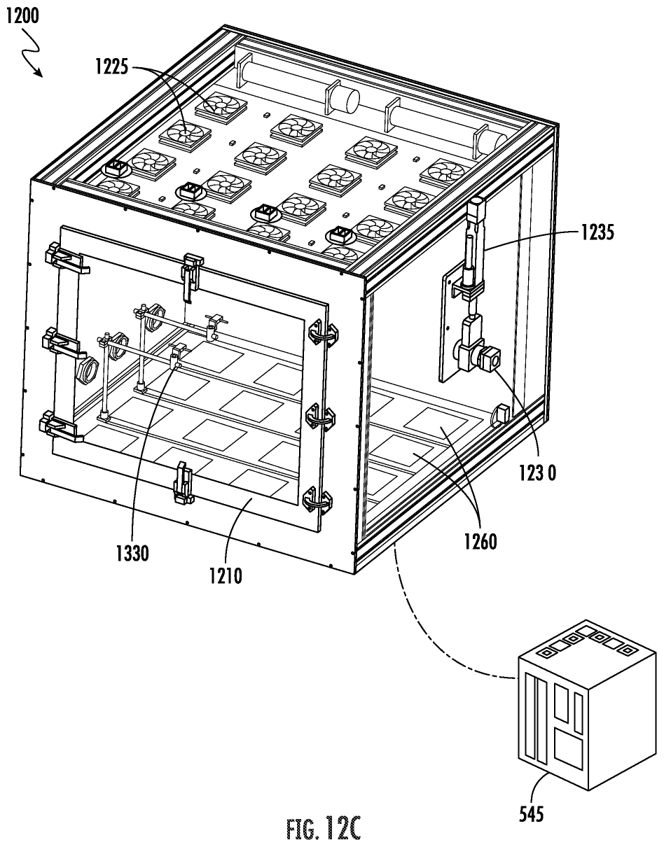

FIGS. 12A-12B are isometric views of an environmental chamber with a coating system 500 inside, in accordance with some embodiments. For example, the coating system 500 is housed in an environmental chamber 1200, to provide highly controlled environmental conditions during the dipping process. FIG. 12C shows an isometric view of the environmental chamber 1200 without the coating system 500 inside, in accordance with some embodiments. The environmental chamber 1200 provides highly accurate temperature, humidity, and airflow conditions for the coating system 500 through localized control of various parameters.

Conventionally, an environmental chamber is filled with static air, and the humidity is decreased to the desired level by adding dry gas such as nitrogen. One challenge is that the dry gas, which is typically input from one location in the chamber, can create non-uniform conditions (e.g., relative humidity) throughout the chamber. Air mixing within the chamber can also be non-uniform, which creates or exacerbates any uneven conditions in the chamber. Another technical challenge is that sensors typically have a delay in their response time. For example, readings from a relative humidity sensor may have a delay on the order of 30 seconds from the real-time conditions, which will then provide inaccurate readings for an environmental controller to respond to. Yet further difficulties are encountered for large chambers, such as having dimensions of several feet per side, in that whenever the chamber is opened, it can take a long time (e.g., at least 30 minutes) to re-establish the desired environmental conditions in the chamber.

FIGS. 12A-12C show that the environmental chamber 1200 is formed by an outer enclosure 1205 with a door 1210 through which the interior of the environmental chamber 1200 can be accessed, such as for loading or removing WIP wires 550 for processing, or for maintaining the coating system 500. The outer enclosure 1205 may be a box, shell, container, or casing that forms the external boundaries of the environmental chamber 1200. The environmental chamber 1200 is illustrated as approximately a rectangular shape in this embodiment but other shapes may be used as needed for the manufacturing system. The environmental chamber 1200 of the present disclosure incorporates several unique features to provide extremely accurate and responsive environmental conditions. These features include a dry gas port 1240, a humid air inlet 1220 (first gas valve 1230), and a carefully designed recirculating airflow path with individually controllable fans 1225. A controller 545, shown in FIG. 12C, is in communication with all these components to provide accurate and uniform conditions in the environmental chamber 1200 in a highly responsive manner.

A first gas valve 1230 is on one side wall of the environmental chamber 1200. The first gas valve 1230 serves as an inlet for humid air, such as ambient air, to raise the relative humidity inside the environmental chamber 1200 when needed. The first gas valve 1230 may include an actuator 1235 that adjusts the amount that the first gas valve 1230 opens when ambient air is needed to be input. The first gas valve 1230 is coupled to the outer enclosure 1205, where the first gas valve 1230 is configured to adjust an amount of humidity-containing gas that enters the environmental chamber 1200. In one embodiment, the first gas valve 1230 and actuator 1235 include a gate that controls the size of a port to allow ambient air into the environmental chamber 1200. The controller 545 causes the first gas valve 1230 to automatically open when a humidity level in the interior of the environmental chamber 1200 is lower than a desired setpoint. The degree to which the first gas valve 1230 opens is based on the change in humidity level needed. A dry gas port 1240 is shown in FIG. 12B, connectable to a dry gas source 1245 (e.g., pure, dry nitrogen having 0% moisture) by a dry gas valve 1250 and gas tubing 1255. The dry gas port 1240 is illustrated on the opposite wall as the first gas valve 1230 in this embodiment but may be coupled to a different wall of the environmental chamber 1200 in other embodiments. The controller 545 causes the dry gas valve 1250 to automatically open when a humidity level in the interior of the environmental chamber 1200 is higher than a desired setpoint, thereby decreasing the relative humidity inside the environmental chamber 1200 when needed. The degree to which the dry gas valve 1250 opens is based on the change in humidity level needed.

A first plurality of fans 1225 is shown in the upper area of the environmental chamber 1200, where the first plurality of fans 1225 are independently controlled from each other. This individualized control of the first plurality of fans 1225 enables localized air flow problems to be addressed, such as to counteract low flow in a particular region of the environmental chamber 1200 (e.g., “dead spots”). Sixteen fans 1225 are shown in this embodiment in a four-by-four array. In other embodiments, more or fewer fans may be utilized, arranged in other patterns or placed as needed based on air pathways created by the presence of the coating system 500 inside the environmental chamber 1200. A plurality of vent plates 1260 (shown in FIG. 12C) is in a bottom area of the environmental chamber 1200, to enable air to recirculate through the environmental chamber 1200. The controller 545 is in communication with the first gas valve 1230, the dry gas valve 1250 and the first plurality of fans 1225.

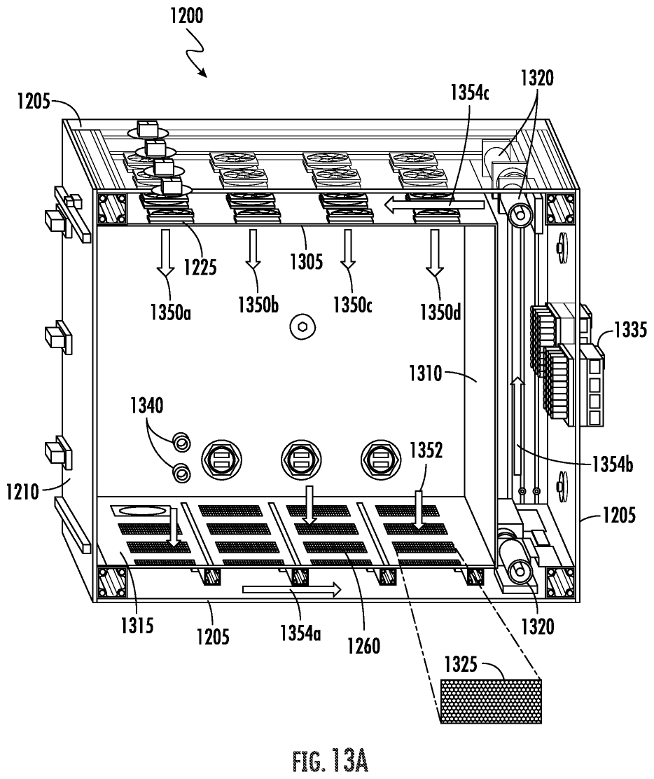

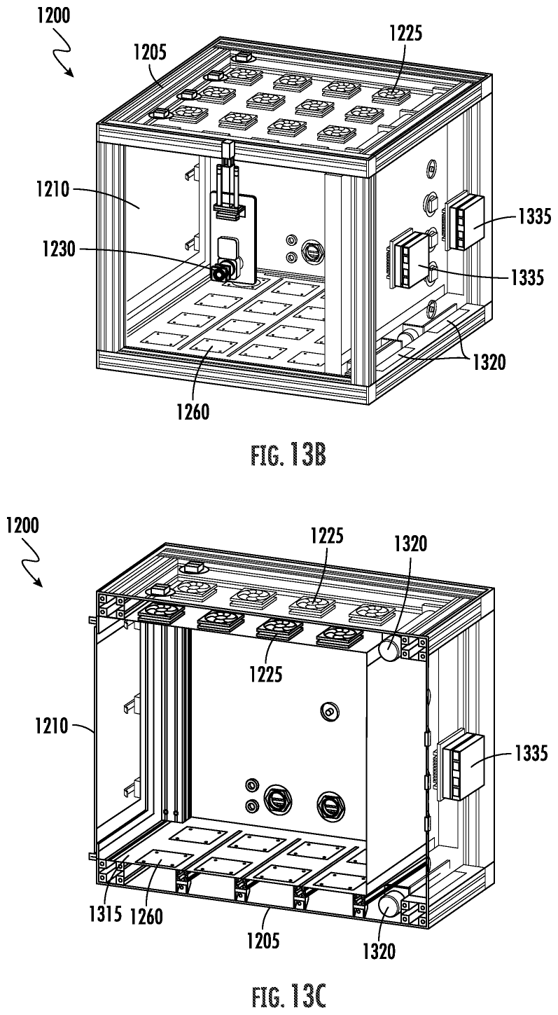

FIGS. 13A-13C are various views showing a recirculation path of an environmental chamber 1200, in accordance with some embodiments. For example, FIGS. 13A-13C show details of the environmental control features of the environmental chamber 1200. FIG. 13A is a side cutaway view, FIG. 13B is an isometric view of the side and back of the environmental chamber 1200, and FIG. 13C is a cutaway view of FIG. 13B. A first wall 1305 is near a top surface of the outer enclosure 1205, a second wall 1310 is near a lateral surface of the outer enclosure 1205, and a third wall 1315 is near a bottom surface of the outer enclosure 1205. The first wall 1305, the second wall 1310 and the third wall 1315 are connected to each other and spaced apart from the outer enclosure 1205 to form a recirculation path between the outer enclosure 1205 and the first wall 1305, the second wall 1310 and the third wall 1315. This recirculation path formed between the outer enclosure 1205 and inner walls (first, second and third walls) is indicated by arrows 1350a-d, 1352, and 1354a-c.

The first plurality of fans 1225 blow air as indicated by arrows 1350a,1350b, 1350c, and 1350d toward the bottom of the environmental chamber 1200, where the air at the bottom of the environmental chamber 1200 passes through the vent plates 1260 as indicated by arrows 1352. Air curtain fans 1320—shown in the lower and upper corners near the rear wall of the environmental chamber 1200—pull the air from the bottom space of the environmental chamber 1200 (arrow 1354a, between the third wall 1315 and outer enclosure 1205), up the back space (arrow 1354b, between the second wall 1310 and outer enclosure 1205), and into the upper space (arrow 1354c, between the first wall 1305 and outer enclosure 1205) where the air can again be distributed into the interior of the environmental chamber 1200 by the first plurality of fans 1225. The first plurality of fans 1225 is coupled to the first wall 1305 and faces an interior of the outer enclosure 1205. Each fan in the first plurality of fans 1225 is individually controllable by the controller 545. The air curtain fans 1320 are a second plurality of fans located within the recirculation path and are also in electrical communication with the controller 545. This arrangement of fans (the first plurality of fans 1225 and air curtain fans 1320) creates a stable pattern of airflow, such as maintaining laminar airflow within the environmental chamber 1200 in one embodiment. The different sizes of airflow arrows 1350a, 1350b, 1350c and 1350d from the first plurality of fans 1225 in FIG. 13A illustrate that the first plurality of fans 1225 can be operated independently from each other, to provide more or less airflow in the vicinity of each fan. This varying airflow may be required, for example, to help distribute dry or humid air that is being input into the environmental chamber 1200, or to compensate for the presence of the coating system 500 within the environmental chamber 1200 that may be blocking airflow in some areas but not others.

The vent plates 1260 are coupled to the third wall 1315 and may be, for example, a mesh, a perforated sheet, or other types of plates having apertures. An example vent 1325 is shown in FIG. 13A, having staggered holes in this embodiment. The vents 1325 across the third wall 1315 may all be the same or may be customized for their particular location. For example, vents 1325 may be configured with less open area (e.g., fewer holes or smaller holes) in locations where less airflow is desired, or more open area where more airflow is desired. In a specific example, a vent 1325 underneath a dense or low airflow area of the coating system 500 may be configured with higher open area than in other locations of the third wall 1315 in order to encourage airflow in that region.

Multiple humidity sensors 1330 are placed at various locations in the environmental chamber 1200 to monitor and provide feedback on relative humidity so that the controller 545 can achieve a uniform humidity throughout the environmental chamber 1200. Examples of humidity sensors 1330 are shown in FIG. 12C. Embodiments include a plurality of humidity sensors 1330, where the controller 545 is in communication with the plurality of humidity sensors 1330 to individually control each fan in the first plurality of fans 1225 according to individual humidity sensors 1330 in the plurality of humidity sensors 1330. The humidity sensors 1330 can be positioned near key locations of the coating system 500, such as near the dry gas port 1240 or first gas valve 1230, the coating station 555d, wire dipping station 555a, holding area 525, and/or cassette area 520. In some embodiments, humidity levels of 13-20% are desired in the environmental chamber 1200 to achieve fast flash of volatiles in the coating solution 315, while still having some humidity present. In some embodiments, the controller 545 monitors humidity levels as well as rates of change in humidity sensed by the humidity sensors 1330. Monitoring a rate of change of humidity can even further improve the accuracy and responsiveness of the environmental chamber 1200, compared to monitoring humidity levels alone. Port connections 1340 in the environmental chamber 1200 allow cables from an external source to pass through into the environmental chamber 1200 for electrical connections, pneumatic connections, or the like.

Temperature affects relative humidity, and thus a temperature control system 1335 is also included in the environmental chamber 1200. In the embodiments of FIGS. 13A-13B, two temperature control systems 1335 are shown, being mounted on the rear surface of the outer enclosure 1205. In one example, one temperature control system 1335 may be for heating and another one may be for cooling. In another example, each temperature control system 1335 may be configured to provide both heating and cooling. The temperature control systems 1335 are in fluid communication with the recirculation path (i.e., coupled to the gas flow in the recirculation path) such that as air passes by, the air is heated or cooled as needed. The temperature control systems 1335 may be, for example a thermoelectric type. The temperature control systems 1335 are also in electrical communication with the controller 545, to provide heating or cooling as needed based on readings from the humidity sensors 1330 as well as from temperature sensors (not shown) in the environmental chamber 1200. In some embodiments, combination sensors may be used that detect both temperature and humidity.

Every time the door 1210 of the environmental chamber 1200 is opened, such as to insert new fixtures 530 or to refill coating solutions 315 or solvents, the relative humidity and temperature need to be re-established to the desired levels. The environmental chamber 1200 reduces the time to reset the required environmental conditions compared to conventional systems, which reduces cycle time and labor costs. Because of the unique design of the environmental chamber 1200 involving features such as independently operating fans 1225, a recirculating flow path, configurable vent plates 1260 and localized feedback from sensors at various locations in the environmental chamber 1200, the environmental chamber 1200 provides a more uniform and accurate environment, and in a more responsive manner, than conventional systems.

Embodiments of systems for coating a working wire 100 of a sensor include the coating system 500 described herein (e.g., coating system 500 of FIGS. 5A-5B) housed in the environmental chamber 1200 described herein (e.g., the environmental chamber 1200 of FIGS. 12A-12C and 13A-13C). In some embodiments, the environmental chamber 1200 may be customized according to the configuration of the coating system 500. For example, at least one vent plate 1260 of the plurality of vent plates 1260 may have an open surface area that is customized according to its location relative to the apparatus for coating the WIP wires 550. In another example, a humidity sensor of the plurality of humidity sensors 1330 may be located near the coating station 555d or the wire dipping station 555a.

The coating systems 500 and environmental chambers 1200 described herein achieve highly accurate coating layers on working wires 100 with a wire dipping process, which is conventionally very difficult to perform accurately.

FIG. 14 is a simplified schematic diagram showing an example server 1400 (representing any combination of one or more of the servers) for use in the controller 545, in accordance with some embodiments. Other embodiments may use other components and combinations of components. For example, the server 1400 may represent one or more physical computer devices or servers, such as web servers, rack-mounted computers, network storage devices, desktop computers, laptop/notebook computers, etc., depending on the complexity. In some embodiments implemented at least partially in a cloud network potentially with data synchronized across multiple geolocations, the server 1400 may be referred to as one or more cloud servers. In some embodiments, the functions of the server 1400 are enabled in a single computer device. In more complex implementations, some of the functions of the computing system are distributed across multiple computer devices, whether within a single server farm facility or multiple physical locations. In some embodiments, the server 1400 functions as a single virtual machine.

In the illustrated embodiment, the server 1400 generally includes at least one processor 1405, a main electronic memory 1410, a data storage 1415, a user input/output (I/O) 1420, and a network I/O 1425, among other components not shown for simplicity, connected or coupled together by a data communication subsystem 1430. A non-transitory computer readable medium 1435 includes instructions that, when executed by the processor 1405, cause the processor 1405 to perform operations including calculations and methods as described herein.

In accordance with the description herein, the various components of the system or method generally represent appropriate hardware and software components for providing the described resources and performing the described functions. The hardware generally includes any appropriate number and combination of computing devices, network communication devices, and peripheral components connected together, including various processors, computer memory (including transitory and non-transitory media), input/output devices, user interface devices, communication adapters, communication channels, etc. The software generally includes any appropriate number and combination of conventional and specially-developed software with computer-readable instructions stored by the computer memory in non-transitory computer-readable or machine-readable media and executed by the various processors to perform the functions described herein.

Reference has been made in detail to embodiments of the disclosed invention, one or more examples of which have been illustrated in the accompanying figures. Each example has been provided by way of explanation of the present technology, not as a limitation of the present technology. In fact, while the specification has been described in detail with respect to specific embodiments of the invention, it will be appreciated that those skilled in the art, upon attaining an understanding of the foregoing, may readily conceive of alterations to, variations of, and equivalents to these embodiments. For instance, features illustrated or described as part of one embodiment may be used with another embodiment to yield a still further embodiment. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only, and is not intended to limit the invention.

What is claimed is:

1. An apparatus for coating a working wire of a sensor, the apparatus comprising:
a carousel comprising:
a first platform having a central axis, the first platform supporting a plurality of stations arranged around the central axis;
a second platform positioned above the first platform, with a platform actuator that raises, lowers, and rotates the second platform with respect to the first platform;
a ring dipping tool coupled to an edge of the second platform, the ring dipping tool being oriented vertically with respect to ground, and extending toward the first platform;
a robotic arm configured to transport a fixture to the carousel, the fixture being configured to hold the working wire; and
an optical scanner positioned near a wire dipping station of the plurality of stations and configured to scan a position of the working wire and a location of the ring dipping tool.

2. The apparatus of claim 1, wherein:
the ring dipping tool is coupled to the edge of the second platform by a linear stage;
a coating station of the plurality of stations comprises a first container configured to hold a coating solution; and
the apparatus further comprises a coating station actuator configured to connect to the linear stage to move the ring dipping tool into the first container.

3. The apparatus of claim 2, further comprising an automated measurement system in communication with the coating station actuator, wherein measurements of coating thicknesses on the working wire, taken by the automated measurement system, provide feedback for controlling the coating station actuator.

4. The apparatus of claim 1, further comprising an automated measurement system and a holding area, wherein the robotic arm is positioned to transport the fixture between the carousel, the automated measurement system, and the holding area.

5. The apparatus of claim 1, further comprising a gas supply tube coupled to the robotic arm, wherein an end of the gas supply tube is near a working end of the robotic arm.

6. The apparatus of claim 1, wherein the optical scanner is in communication with the robotic arm such that the robotic arm uses the position of the working wire and the location of the ring dipping tool to insert the working wire through the ring dipping tool at the wire dipping station of the plurality of stations.

7. The apparatus of claim 1, wherein a cleaning station of the plurality of stations comprises a second container configured to hold a solvent.

8. The apparatus of claim 1, wherein the fixture is configured to hold a plurality of working wires, the plurality of working wires being spaced apart from each other.

9. The apparatus of claim 8, further comprising a controller in communication with the robotic arm, wherein the controller moves the robotic arm and rotates the carousel such that the plurality of working wires is processed by the carousel.

10. The apparatus of claim 1, further comprising a plurality of ring dipping tools coupled to the edge of the second platform and spaced apart from each other at locations corresponding to each station of the plurality of stations.

11. The apparatus of claim 1, further comprising an environmental chamber comprising:
an outer enclosure;
a first wall near a top surface of the outer enclosure, a second wall near a lateral surface of the outer enclosure, and a third wall near a bottom surface of the outer enclosure, wherein the first wall, the second wall and the third wall are connected to each other and spaced apart from the outer enclosure to form a recirculation path between the outer enclosure and the first wall, the second wall and the third wall;
a first plurality of fans coupled to the first wall and facing an interior of the outer enclosure;
a second plurality of fans located within the recirculation path;
a plurality of vent plates coupled to the third wall;
a first gas valve coupled to the outer enclosure, wherein the first gas valve is configured to adjust an amount of humidity-containing gas that enters the environmental chamber;
a dry gas valve coupled to the outer enclosure; and
a controller in communication with the first gas valve, the dry gas valve, and the first plurality of fans, wherein each fan of the first plurality of fans is configured to be individually controlled by the controller.

12. The apparatus of claim 11, wherein the environmental chamber further comprises a plurality of humidity sensors, wherein the controller is in communication with the plurality of humidity sensors to individually control each fan of the first plurality of fans according to individual humidity sensors in the plurality of humidity sensors.

13. The apparatus of claim 12, wherein the controller monitors a rate of change of humidity in the environmental chamber, sensed by the plurality of humidity sensors.

14. The apparatus of claim 11, wherein the controller causes the first gas valve to open when a humidity level in the interior of the environmental chamber is lower than a desired setpoint.

15. The apparatus of claim 11, wherein the controller causes the dry gas valve to open when a humidity level in the interior of the environmental chamber is higher than a desired setpoint.

16. The apparatus of claim 11, wherein the environmental chamber further comprises a temperature control system in fluid communication with the recirculation path.

17. An apparatus for coating a working wire of a sensor, the apparatus comprising:
a ring dipping tool having a ring and a shaft, the shaft being oriented vertically with respect to ground;
a robotic arm configured to transport the working wire;
an optical scanner in communication with the robotic arm and configured to scan a position of the working wire and a location of the ring dipping tool;
a wire dipping station having a container configured to hold a coating solution; and
a coating station actuator configured to move the ring dipping tool into the container;
wherein the robotic arm uses the position of the working wire and the location of the ring dipping tool to insert the working wire through the ring of the ring dipping tool.

18. The apparatus of claim 17, further comprising an automated measurement system in communication with the coating station actuator, wherein measurements of coating thicknesses on the working wire, taken by the automated measurement system, provide feedback for controlling the coating station actuator.

19. The apparatus of claim 17, further comprising a controller in communication with the robotic arm, wherein the controller moves the robotic arm such that a plurality of working wires is processed.

20. The apparatus of claim 17, further comprising a plurality of ring dipping tools spaced apart from each other on a platform of a carousel.
